(19) United States
(12) Patent Application Publication
(10) Pub. No.: US 2007/0097149 A1
(43) Pub. Date: May 3, 2007

(54) Utility, method and device providing vector images that may be updated to reflect the presence of removable components of a device

(76) Inventors: Andrew Christopher Walton, Rocklin, CA (US); Christopher William Brown, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,966

(22) Filed: Oct. 27, 2005

(51) Int. Cl. G09G 5/00

(52) U.S. Cl. 345/629

(57) ABSTRACT

In one embodiment, in response to receiving an image request, a computer-implemented method 1) retrieves a vector image from a device that is a target of the image request, the vector image illustrating at least a portion of the device; 2) retrieves component presence information for a removable component of the device; 3) formats the vector image in response to the component presence information by, A) identifying a component tag within the vector image, the component tag being associated with the removable component, and a set of vectors defining a component image and B) in accord with the component presence information for the removable component, setting a display indicator corresponding to the component tag, the display indicator affecting display of the component image during display of the vector image; and 4) returns a formatted version of the vector image. Other embodiments are also disclosed.

### BACKGROUND

The management of a device is typically aided by providing its user with a means to graphically visualize the device. In some cases, one or more images of a device and its components may be included within paper or electronic documentation (e.g., a user manual). In other cases, a device may be provided with stickers showing one or more views of the device's interior components.

In still other cases, images of a device may be incorporated into a management tool for the device. For example, a print driver may display an image of the printer to which it corresponds, or a server management tool may display various images associated with the server components of which the management tool is aware or can manage (e.g., the server's memory modules, interfaces, or storage disks).

Many devices for which graphical images are needed are subject to change. That is, the devices may be upgradeable such that additional components (e.g., memory modules, interfaces, or storage disks) may be inserted into or attached to the device. Thus, an issue facing the image creator is whether to draw an image of each configuration of the device or draw a single “exemplary” image in which the device is depicted in one particular “default” configuration.

A device may also be subject to change over its lifecycle. That is, the styling of the device's exterior, the suppliers of its internal components, its “default” configuration, and even its available features can change over its lifecycle. Thus, any images pertaining to the first generation of the device may not accurately depict later generations of the device.

As one can appreciate, the creation and maintenance of graphical images for a device can present a significant burden for both device manufacturers and third-party device supporters (e.g., management tool developers).

### SUMMARY OF THE INVENTION

In one embodiment, an image formatting utility comprises code to, in response to receiving an image request, 1) retrieve a vector image from a device that is a target of the image request, the vector image illustrating at least a portion of the device; 2) retrieve component presence information for a removable component of the device; 3) format the vector image in response to the component presence information by, A) identifying a component tag within the vector image, the component tag being associated with the removable component, and a set of vectors defining a component image; and B) in accord with the component presence information for the removable component, setting a display indicator corresponding to the component tag, the display indicator affecting display of the component image during display of the vector image; and 4) return a formatted version of the vector image.

In another embodiment, an article of manufacture comprises computer-readable media, and computer-readable code that is stored on the computer-readable media. The computer-readable code includes code to, in response to receiving an image request, 1) retrieve a vector image from a device that is a target of the image request, the vector image illustrating at least a portion of the device; 2) retrieve component presence information for a removable component of the device; 3) format the vector image in response to the component presence information by, A) identifying a component tag within the vector image, the component tag being associated with i) the removable component, and ii) a set of vectors defining a component image; and B) in accord with the component presence information for the removable component, setting a display indicator corresponding to the component tag, the display indicator affecting display of the component image during display of the vector image; and 4) return a formatted version of the vector image.

In yet another embodiment, a computer-implemented method for formatting images of a device comprises, in response to receiving an image request, 1) retrieving a vector image from a device that is a target of the image request, the vector image illustrating at least a portion of the device; 2) retrieving component presence information for a removable component of the device; 3) formatting the vector image in response to the component presence information by, A) identifying a component tag within the vector image, the component tag being associated with the removable component, and a set of vectors defining a component image; and B) in accord with the component presence information for the removable component, setting a display indicator corresponding to the component tag, the display indicator affecting display of the component image during display of the vector image; and 4) returning a formatted version of the vector image.

In still another embodiment, a device comprises a non-volatile memory in which an image illustrating at least a portion of the device is stored. The image comprises a plurality of vectors and a component tag. The component tag is associated with a removable component of the device, a set of vectors defining a component image, and an editable display indicator that affects display of the component image during display of the vector image. The device also comprises an interface to, upon receiving a request for the vector image, return the vector image.

Other embodiments are also disclosed.

### BRIEF DESCRIPTION OF THE DRAWINGS

Illustrative embodiments of the invention are illustrated in the drawings, in which:

FIG. 1 illustrates an exemplary system in which an image formatting utility may be used;

FIG. 2 illustrates a first exemplary embodiment of the image formatting utility shown in FIG. 1;

FIG. 3 illustrates an exemplary vector image wherein a display indicator associated with a component image, CPU_1, is set to “visible”;

FIG. 4 illustrates a display of the vector image shown in FIG. 3;

FIG. 5 illustrates a modification of the vector image shown in FIG. 3, wherein the display indicator associated with the component image CPU_1 is set to “invisible”; and

FIG. 6 illustrates a display of the vector image shown in FIG. 5.

### DETAILED DESCRIPTION

One development that has eased the burden of creating and maintaining graphical images for a device is the electronic storage of a device's images within the device itself. For example, different images pertaining to different views and/or components of a device may be saved as Scalable Vector Graphics (SVG) images, or other easy-to-manipulate image types, and stored within a non-volatile memory of the device (preferably, but not always, in the device's firmware). Thus, a management tool for the device no longer needs to provide its own set of images for the device. Rather, the management tool need only be provided with abilities to 1) query the device to retrieve an image of the device, and 2) format the image to reflect the current state of the device. In this manner, the developer of the management tool need not be concerned with how the device looks, and can instead focus on how the device functions and is managed.

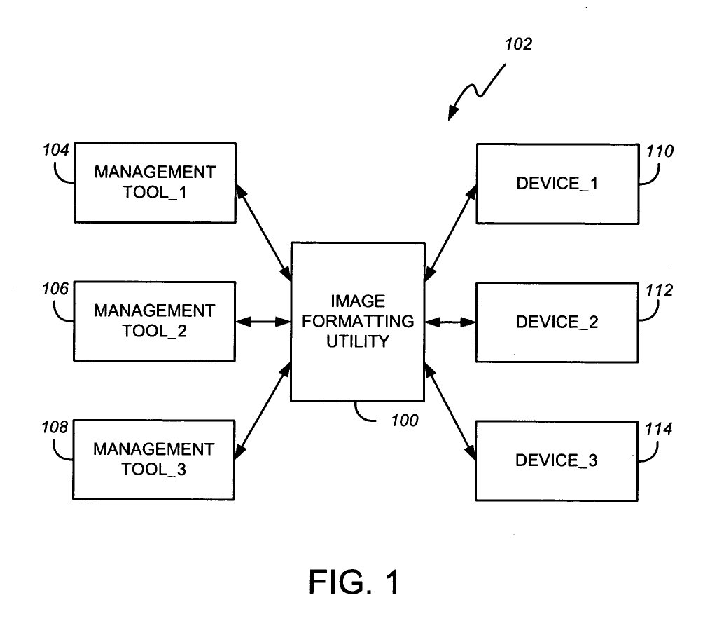

To further ease a management tool developer's burden of having to work with device images, an image formatting utility 100 (FIGS. 1 & 2), and system incorporating same, are disclosed herein. By way of example, the “utility” 100 may take the form of an application or browser plug-in that is embodied in computer-readable code stored on one or more computer-readable media. The computer-readable media may include, for example, any number or mixture of fixed or removable media (such as one or more fixed disks, random access memories (RAMs), read-only memories (ROMs), or compact discs), at either a single location or distributed over a network.

Before describing the image formatting utility 100 in detail, an exemplary system 102 (FIG. 1) in which the image formatting utility 100 may be used will be described.

The system 102 comprises one or more device management tools 104, 106, 108 for generating image requests, and one or more devices 110, 112, 114 that may be targets of the image requests. Each of the devices 110-114 is provided with a non-volatile memory in which one or more images (i.e., an image set) illustrating at least a portion of the device is stored. Assuming that the management tools 104-108 and devices 110-114 comprise interfaces that are compatible with those of the image formatting utility 100, the utility 100 may 1) receive plural image requests from any one or more of the management tools 104-108, and 2) in responding to the plural image requests, format images retrieved from a plurality of the devices 110-114 and return the formatted images to the requesting ones of the management tools 104-108. Of note, the management tools 104-108 and devices 110-114 of the system 102 have no direct link to, nor dependence on, each other. Thus, one or the other can easily be modified or appended to without affecting the other. Furthermore, the image(s) stored within the devices 110-114 can be updated without any need to worry about how the updated images will be drawn by the utility 100 or the management tools 104-108.

The management tools 104-108 of the system 102 may take various forms, including, for example, those of a: print driver, configuration manager, licensing manager, server manager, system manager, or network manager. In one embodiment of the system 102, one or more of the device management tools 104-108 may present a user interface (e.g., a graphical user interface (GUI)) through a web browser.

The devices 110-114 of the system 102 may also take various forms, including, for example, those of a: server, computer system, printer, or network. Further, the devices in which images are stored may be parts of other devices. For example, images may be stored in a memory of a computer motherboard, while additional images may be stored in a configurable video or networking card that has been inserted into a slot of the motherboard.

In one embodiment, the image or images (i.e., image set) stored within a device comprise SVG images. SVG is a language for describing two-dimensional graphics and graphical applications in extensible markup language (XML). SVG specifications are published by the World Wide Web Consortium (W3C®). SVG images are particularly suited to being stored in a device as a result of their small storage requirements, scalable size, and configurability. Alternately, a device's image set may comprise other types of easy-to-manipulate images, such as other vector-based images (e.g., postscript images).

Each device 110-114 may store its image set in a non-volatile memory. The images in each image set illustrate at least a portion of the device in which they are stored, and in some cases may illustrate different portions or views of the device. For purposes which will become clear later in this description, one or more of the stored images may be vector images comprising a number of embedded component tags, each tag of which is associated with 1) a removable component of the device in which the image is stored, 2) a set of vectors defining a different one of a number of component images, and 3) an editable display indicator that affects display of the component image during display of the vector image.

In a simple embodiment, each of the devices 110-114 need only have an ability to fetch and return its stored image set (possibly only one image). However, in other embodiments, a device interface may have an ability to fetch a particular image (e.g., via address, number or type). A device interface may also return component presence and status information for the device, although it need not.

Although the exemplary system 102 illustrates the utility 100 being stored and executed apart from any management tool 104-108 or device 110-114, the utility 100 could alternately be stored and executed locally to a particular management tool or device (e.g., within the device).

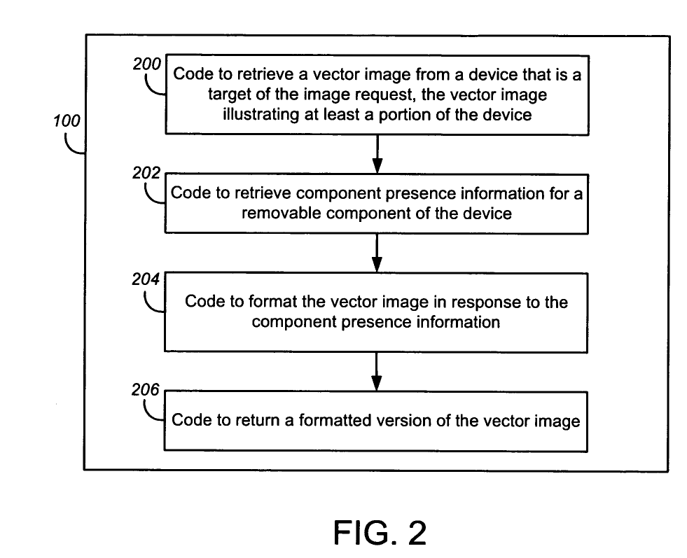

Having described exemplary contexts in which the utility 100 may be used, the utility 100 will now be described in greater detail. As shown in FIG. 2, the utility 100 comprises code 200 to, in response to receiving an image request from a device management tool, retrieve a vector image from a device that is a target of the image request. Before, during or after retrieval of the vector image, code 202 retrieves component presence information for a removable component of the device. For example, code 202 may retrieve component presence information for a processor or memory card that may be installed on a motherboard. When a plurality of removable components may be installed on a device, code 202 preferably retrieves component presence information for all of the components.

In one embodiment, code 200 first retrieves a vector image, and code 202 then parses the vector image to identify a set of removable components for which presence information is needed. In another embodiment, code 202 merely issues a general query for a device's component presence information.

In one embodiment, queries issued by the code 202 are made to the device from which a vector image is retrieved. Alternately (or additionally), the utility 100 may retrieve component presence information from an operating system that interfaces with the device, or from one or more management tools of which the utility 100 is aware.

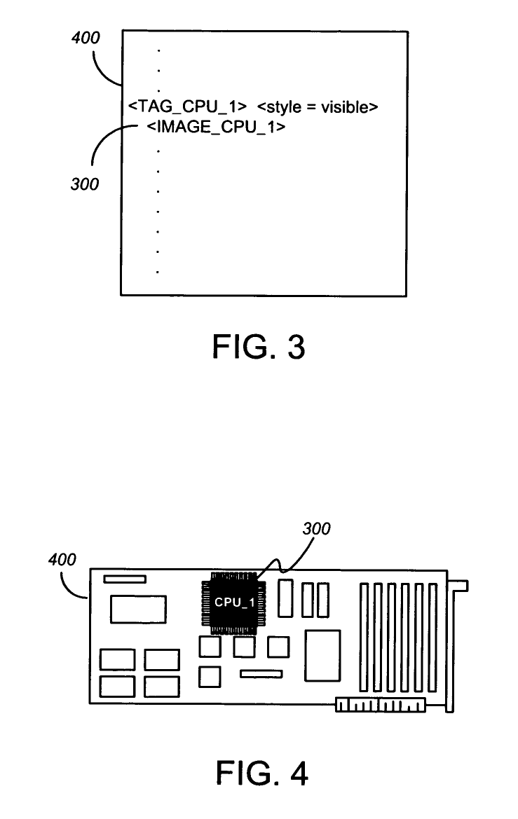

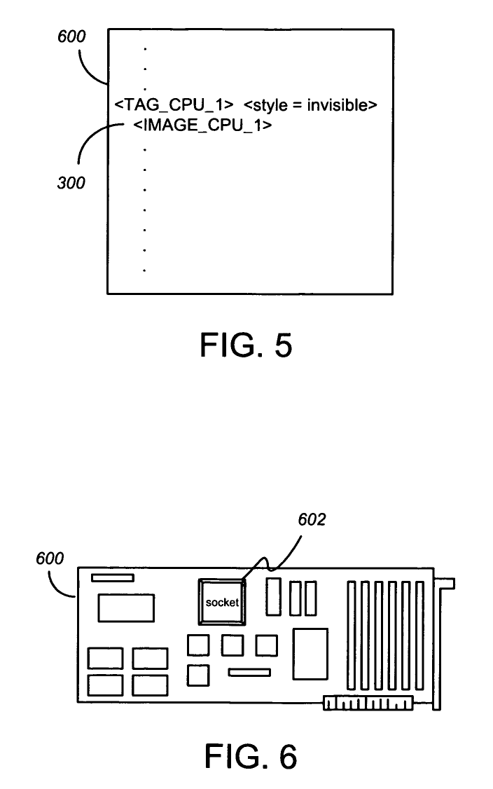

After retrieving the component presence information, code 204 formats the vector image in response to the component presence information. This is done by first identifying a component tag within the vector image, the tag being associated with 1) the removable component, and 2) a set of vectors defining a component image. Then, in accord with the component presence information for the removable component, a display indicator corresponding to the component tag is set. By setting the display indicator, display of the component image during display of the vector image is affected. For example, and as shown in FIGS. 3 & 4, if a display indicator (“style”, FIG. 3) for a component image (CPU_1) is set to “visible”, the component image 300 may be displayed as shown in FIG. 4. Because the component image 300 is contained within the vector image 400, its placement, size and orientation with respect to the vector image 400 is fixed, and there is no need to determine how to display the component image 300 if CPU_1 is present. On the other hand, and as shown in FIGS. 5 & 6, if the display indicator (“style”, FIG. 5) for the component image (CPU_1) is set to “invisible”, the vector image 600 may be displayed without the component image 300, as shown in FIG. 6. When the component image 300 is made invisible, parts of the vector image 600 (e.g., socket 602) which the component image 300 would otherwise overlay may be seen.

Instead of (or in addition to) the display indicators of “visible” and “invisible”, a display indicator may be set to make a component image opaque (if present) or translucent (if absent). A display indicator could also be set to cause a component image to be drawn in one of a plurality of colors (e.g., black if present, and red if absent). A display indicator may also be set to cause the component image to be drawn with a fill-pattern (e.g., green if present, and red if absent; or solid if present, and hatched if absent). It should also be noted that the setting of a display indicator to “invisible” or “translucent” may cause default hatching, or some other default indicator contained within a vector image, to be revealed.

Optionally, the utility 100 may comprise code to retrieve component status information for a removable component. As with the code 202, the code to retrieve component status information may issue queries to the device from which a vector image is retrieved, to an operating system that interfaces with the device, or to one or more management tools of which the utility 100 is aware. The retrieved status information may be as simple as positive/negative indications of whether components are functioning as desired. Alternately, the status information may comprise additional information regarding the quality or consistency of a component's performance.

If status information for the removable component can be retrieved, the code 106 may further format a vector image in response to the status information. For example, in addition to being set in accord with component presence information, a display indicator may be set in accord with component status information (e.g., if a component is present and working, its display indicator might be set to “visible, green”, and if a component is present but not working, its display indicator might be set to “visible, red”).

In addition to using component status information to provide a display indicator with multiple settings, component status information may be used to set the display indicators of multiple images. For example, if the utility 100 identifies multiple component tags within a vector image, a plurality of which correspond to a single removable component, the utility 100 may use component status information to set the display indicator of an appropriate one of the plural images to “visible”. Consider, for example, a component that may assume varied and complex physical states. Instead of representing these different states by changing the color or fill-pattern of a single component image, different component images could be provided for the component's different states, and the display indicators of the various component images could be modified so as to make an appropriate one of the component images visible (and make the rest invisible).

Upon formatting a vector image using component presence information (and possibly component status information), code 206 (FIG. 2) returns a formatted version of the vector image to the device management tool that requested the image.

In some cases, the formatted image returned by the code 206 may comprise a formatted image that is in the native format of a retrieved vector image (e.g., an SVG format). In other cases, the formatting of a vector image may comprise rendering the image (i.e., converting the image to a raster-based format).

As previously indicated, the code 200-206 may be included within a utility 100 that stands apart from other management tools 104-108 and devices 110-114. Alternately, instances of the code 200-206 may be provided as part of the management tools 104-108, or may be stored and executed by the devices 110-114.

Although the above description has primarily focused on the setting of a display indicator for one component image (or a group of component images corresponding to one removable component), it is envisioned that the code 200-206 disclosed herein may be used to simultaneously set the display indicators for multiple removable components.

What is claimed is:

1. An image formatting utility, comprising:
code to, in response to receiving an image request,
retrieve a vector image from a device that is a target of the image request, the vector image illustrating at least a portion of the device;
retrieve component presence information for a removable component of the device;
format the vector image in response to the component presence information by,
identifying a component tag within the vector image, the component tag being associated with i) the removable component, and ii) a set of vectors defining a component image; and
in accord with the component presence information for the removable component, setting a display indicator corresponding to the component tag, the display indicator affecting display of the component image during display of the vector image; and
return a formatted version of the vector image.

2. The image formatting utility of claim 1, further comprising:
code to, in response to receiving the image request,
retrieve component status information for the removable component; and
format the vector image in response to the component status information by,
identifying at least one additional component tag within the vector image, wherein each of the component tags is associated with i) the removable component, and ii) a component image reflecting a different status of the removable component; and
in accord with the component status information for the removable component, setting different display indicators corresponding to different ones of the component tags.

3. The image formatting utility of claim 1, further comprising:
code to, in response to receiving the image request, retrieve component status information for the removable component;
wherein the code to format the vector image further sets the display indicator in accord with the component status information.

4. The image formatting utility of claim 1, wherein the code to format the vector image sets the display indicator to make the component image visible or invisible.

5. The image formatting utility of claim 1, wherein the code to format the vector image sets the display indicator to make the component image opaque or translucent.

6. The image formatting utility of claim 1, wherein the code to format the vector image sets the display indicator to cause the component image to be drawn in one of a plurality of colors.

7. The image formatting utility of claim 1, wherein, if the component presence information indicates that the removable component is absent, the code to format the vector image sets the display indicator to cause the component image to be drawn with a fill-pattern.

8. An article of manufacture, comprising:
computer-readable media; and
computer-readable code, stored on the computer-readable media, including code to, in response to receiving an image request,
retrieve a vector image from a device that is a target of the image request, the vector image illustrating at least a portion of the device;
retrieve component presence information for a removable component of the device;
format the vector image in response to the component presence information by,
identifying a component tag within the vector image, the component tag being associated with i) the removable component, and ii) a set of vectors defining a component image; and
in accord with the component presence information for the removable component, setting a display indicator corresponding to the component tag, the display indicator affecting display of the component image during display of the vector image; and
return a formatted version of the vector image.

9. A computer-implemented method for formatting images of a device, comprising:
in response to receiving an image request,
retrieving a vector image from a device that is a target of the image request, the vector image illustrating at least a portion of the device;
retrieving component presence information for a removable component of the device;
formatting the vector image in response to the component presence information by,
identifying a component tag within the vector image, the component tag being associated with i) the removable component, and ii) a set of vectors defining a component image; and
in accord with the component presence information for the removable component, setting a display indicator corresponding to the component tag, the display indicator affecting display of the component image during display of the vector image; and
returning a formatted version of the vector image.

10. The method of claim 9, further comprising:
in response to receiving the image request,
retrieving component status information for the removable component; and
formatting the vector image in response to the component status information by,
identifying at least one additional component tag within the vector image, wherein each of the component tags is associated with i) the removable component, and ii) a component image reflecting a different status of the removable component; and
in accord with the component status information for the removable component, setting different display indicators corresponding to different ones of the component tags.

11. The method of claim 9, further comprising:
in response to receiving the image request, retrieving component status information for the removable component;
wherein formatting the vector image further comprising setting the display indicator in accord with the component status information.

12. The method of claim 9, wherein formatting the vector image further comprises setting the display indicator to make the component image visible or invisible.

13. The method of claim 9, wherein formatting the vector image further comprises setting the display indicator to make the component image opaque or translucent.

14. The method of claim 9, wherein formatting the vector image further comprises setting the display indicator to cause the component image to be drawn in one of a plurality of colors.

15. The method of claim 9, wherein, if the component presence information indicates that the removable component is absent, the vector image is formatted by setting the display indicator to cause the component image to be drawn with a fill-pattern.

16. A device, comprising:
a non-volatile memory in which an image illustrating at least a portion of the device is stored, the image comprising a plurality of vectors and a component tag, the component tag being associated with i) a removable component of the device, ii) a set of vectors defining a component image, and iii) an editable display indicator that affects display of the component image during display of the vector image; and
an interface to, upon receiving a request for the vector image, return the vector image.

17. The device of claim 16, further comprising:
code to, in response to receiving a request for the vector image,
retrieve component presence information for the removable component;
format the vector image in response to the component presence information by setting the display indicator in accord with the component presence information; and
return the formatted image to the device management tool.

18. The device of claim 17, further comprising:
code to, in response to receiving a request for the vector image,
retrieve component status information for the removable component; and
format the vector image in response to the component status information by,
identifying at least one additional component tag within the vector image, wherein each of the component tags is associated with i) the removable component, and ii) a component image reflecting a different status of the removable component; and
in accord with the component status information for the removable component, setting different display indicators corresponding to different ones of the component tags.

19. The device of claim 16, wherein the component image overlays other vectors of the vector image.

20. The device of claim 19, wherein vectors defining parts of the vector image overlaid by the component image define a fill-pattern.

21. The device of claim 16, wherein the display indicator assumes a state of visible or invisible.
